(19) United States
(12) Patent Application Publication
(10) Pub. No.: US 2013/0117530 A1
(43) Pub. Date: May 9, 2013

(54) APPARATUS FOR TRANSLATING VIRTUAL ADDRESS SPACE

(71) Applicant: Electronics and Telecommunications Research In, Daejeon (KR)

(72) Inventors: Kang Ho Kim, Daejeon (KR); Kwang Won Koh, Daejeon (KR); Chei Yol Kim, Daejeon (KR); Soo Cheol Oh, Daejeon (KR); Seung Hyub Jeon, Daejeon (KR); Young Woo Jung, Seoul (KR); Chang Won Ahn, Daejeon (KR)

(73) Assignee: Electronics and Telecommunications Research Institute, Daejeon (KR)

(21) Appl. No.: 13/669,940

(22) Filed: Nov. 6, 2012

(30) Foreign Application Priority Data
Nov. 7, 2011 (KR) 10-2011-0115357

(51) Int. Cl. G06F 12/10

(52) U.S. Cl. 711/206; 711/E12.061

(57) ABSTRACT

The apparatus includes a virtual address space generation unit generating a virtual address space of a guest operating system, the guest operating system being executed in the virtual address space, and a virtual address space of a virtual machine monitor, the virtual machine monitor being executed in the virtual address space; a gateway page generation unit generating a gateway page allocated to a predetermined region of an actual memory region and mapped to the virtual address space of the guest operating system and the virtual address space of the guest machine monitor; and a memory management unit executing the gateway page to map a kernel region of the guest operating system to the predetermined region of the virtual address space of the virtual machine monitor to perform translation between the virtual address space of the guest operating system and the virtual address space of the virtual machine monitor.

### CLAIM FOR PRIORITY

This application claims priority to Korean Patent Application No. 10-2011-0115357 filed on Nov. 7, 2011 in the Korean Intellectual Property Office (KIPO), the entire contents of which are hereby incorporated by reference.

### BACKGROUND

1. Technical Field

Example embodiments of the present invention relate in general to virtualization technology, and more specifically, to an apparatus for translating a virtual address space which can quickly translate a virtual address space between a virtual machine monitor and a guest operating system, or between a guest operating system and a host operating system, to facilitate access to the guest operating system during execution of the virtual machine monitor.

2. Related Art

In virtual machine environments, a plurality of virtual machines may be implemented on one actual machine, and an operating system may run on each virtual machine. A virtual machine monitor, which may be implemented in software, monitors instructions executed by a guest operating system running on the virtual machine.

The virtual machine monitor allows the guest operating system to execute instructions such as CPU register operation, etc. among instructions executed by the guest operating system, and does not allow the guest operating system to execute virtualization-sensitive instructions such as a change in the setting of a memory management unit, an enable/disable setting, etc., and directly execute virtualization-sensitive instructions instead of the guest operating system. The virtual machine monitor allows the guest operating system to recognize virtualization-sensitive instructions as being executed on the virtual machine which provides a virtualization environment to the guest operating system.

In order for the virtual machine monitor to execute virtual-sensitive instructions, a virtual address space is required to be translated from the guest operating system to the virtual machine monitor, the virtual machine monitor accesses instructions and data of the guest operating system to perform tasks, and then the virtual address space is required to be translated back to the guest operating system.

For para-virtualization, the source code of the guest operating system is modified to install the virtual machine monitor in a portion of the virtual address space of the guest operating system, so that the virtual address space need not be translated between the virtual machine monitor and the guest operating system. For full-virtualization, however, the virtual address space is frequently translated between the virtual machine monitor and the guest operating system in order for the virtual machine monitor to process the virtualization-sensitive instructions of the guest operating system.

However, in conventional full-virtualization technique, only a method using a shared area is used to translate the virtual address space between the virtual machine and the guest operating system.

In a case where the virtual machine monitor translates the virtual address space between the virtual machine monitor and the guest operating system, there are problems in that the virtual address space of the guest operating system should be applied to a page table of the virtual machine monitor whenever the virtual address space is changed, and thus the task of applying the virtual address space of the guest operating system to the page table of the virtual machine monitor deteriorates performance of the virtual machine and increases the amount of used memory.

### SUMMARY

Accordingly, example embodiments of the present invention are provided to substantially obviate one or more problems due to limitations and disadvantages of the related art.

Example embodiments of the present invention provide an apparatus for effectively translating the virtual address space between the virtual machine monitor and the guest operating system by arranging and translating the virtual address space on the basis of characteristics of a memory management unit.

The object of the present invention is not limited to the aforesaid, but other objects not described herein will be clearly understood by those skilled in the art from descriptions below.

In some example embodiments, an apparatus for translating a virtual address space includes: a virtual address space generation unit generating a virtual address space of a guest operating system, the guest operating system being executed in the virtual address space, and a virtual address space of a virtual machine monitor, the virtual machine monitor being executed in the virtual address space; a gateway page generation unit generating a gateway page allocated to a predetermined region of an actual memory region and mapped to the virtual address space of the guest operating system and the virtual address space of the virtual machine monitor; and a memory management unit executing the gateway page to map a kernel region of the guest operating system to the predetermined region of the virtual address space of the virtual machine monitor to perform translation between the virtual address space of the guest operating system and the virtual address space of the virtual machine monitor.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a virtualization apparatus according to an embodiment of the present invention;

FIG. 2 is a concept view illustrating arrangement of the virtual address space of the guest operating system and the virtual machine monitor according to an embodiment of the present invention;

FIG. 3 is a block diagram illustrating a schematic configuration of the gateway page according to an embodiment of the present invention;

FIG. 4 is a concept view illustrating a control flow when the virtual address space is translated through the gateway page between the guest operating system and the virtual machine monitor according to an embodiment of the present invention;

FIG. 5 is a flowchart illustrating a process of translating the virtual address space between the guest operating system and the virtual machine monitor according to an embodiment of the present invention;

FIG. 6 is a concept view illustrating arrangement of the virtual address space translated when the virtual machine monitor is executed according to an embodiment of the present invention;

FIG. 7 is a concept view illustrating a process of translating the virtual address space between the guest operating system of the type-2 virtual machine monitor and the virtual machine monitor according to an embodiment of the present invention;

FIG. 8 is a concept view illustrating arrangement of the virtual address space in the process S2 of translating the virtual address space in the type-2 virtual machine monitor according to an embodiment of the present invention;

FIG. 9 is a concept view illustrating arrangement of the virtual address space in the process S1 of translating the virtual address space in the type-2 virtual machine monitor according to an embodiment of the present invention;

FIG. 10 is a concept view illustrating arrangement of the virtual address space in the process S0 of translating the virtual address space in the type-2 virtual machine monitor; and

FIG. 11 is a concept view illustrating a relationship between virtual address spaces between a plurality of guest operating systems in the type-2 virtual machine monitor and the virtual machine monitor.

### DESCRIPTION OF EXAMPLE EMBODIMENTS

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, in the embodiments of the present invention, apparatus and method for translating virtual address space may be implemented on a processor including a memory management unit. In particular, the processor including the memory management unit may be an ARM processor, but it is not limited thereto.

An apparatus for translating a virtual address space according to an embodiment of the present invention may include: a virtual address space generation unit generating a virtual address space of a guest operating system, the guest operating system being executed in the virtual address space, and a virtual address space of a virtual machine monitor, the virtual machine monitor being executed in the virtual address space; a gateway page generation unit generating a gateway page allocated to a predetermined region of an actual memory region and mapped to the virtual address space of the guest operating system and the virtual address space of the virtual machine monitor; and a memory management unit executing the gateway page to map a kernel region of the guest operating system to the predetermined region of the virtual address space of the virtual machine monitor to perform translation between the virtual address space of the guest operating system and the virtual address space of the virtual machine monitor.

Also an apparatus for translating a virtual address space according to an embodiment of the present invention may include: a virtual address space generation unit generating a virtual address space of a guest operating system, the guest operating system being executed in the virtual address space, and a virtual address space of a host operating system, the host operating system being executed in the virtual address space; a gateway page generation unit generating a gateway page allocated to a predetermined region of an actual memory region and mapped to the virtual address space of the guest operating system and the virtual address space of the host operating system; and a memory management unit executing the gateway page to map a guest operating system user region of the guest operating system to the predetermined region of the virtual address space of the host operating system to perform translation between the virtual address space of the guest operating system and the virtual address space of the host operating system.

Hereinafter, embodiments of the present invention will be described in detail with reference to the accompanying drawings.

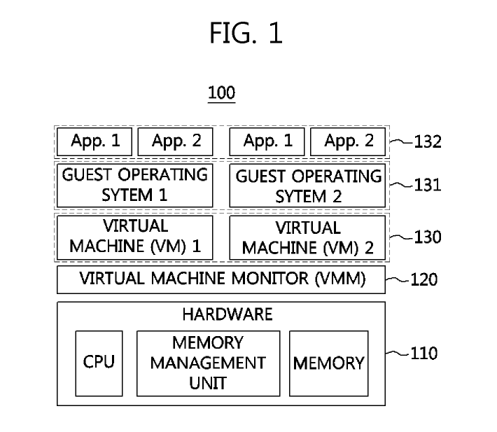

FIG. 1 is a block diagram illustrating a virtualization apparatus according to an embodiment of the present invention.

Referring to FIG. 1, the virtualization apparatus 100 may include hardware 110, a virtual machine monitor (VMM) 120, a virtual machine (VM), a guest operating system 131, and an application 132.

The hardware 110 may be a computer device such as a personal computer, a mobile computer device, etc. and a computing platform for running the guest operating system or the virtual machine monitor, which may include a central processing unit (CPU) executing an operation according to instructions provided to the guest operating system or virtual machine monitor, a memory management unit (MMU) performing translation between a virtual address provided from the CPU and a physical address of an actual memory region, and a memory corresponding to the actual memory region.

The MMU may include a translation table base register TTBR storing an address stored in a page table for connecting the virtual address space with the actual memory region, and a translation table base control register TTBCR determining operation of the TTBR. The memory may be a variety of media for storing data such as a hard disk, a floppy disk, a random access memory (RAM), a read only memory (ROM), and a flash memory.

The virtual machine monitor 120 may be executed on the hardware 110. The virtual machine monitor 120 may execute a virtual machine 130 which is an environment running the guest operating system. The virtual machine monitor 120 may be implemented in software, firmware, etc., and executed on other virtual machine monitors.

Also, the virtual machine monitor 120 may execute the virtual machine 130, and control the hardware in order to protect the virtual machine monitor 120 from the virtual machine 130.

Furthermore, the virtual machine monitor 120 performs translation between a virtual address space of the guest operating system and a virtual address space of the virtual machine monitor in order to process an interrupt occurring in the guest operating system, an exception for executing an undefined instruction, an instruction for performing an authority-required function of the operating system, for example, a virtualization-sensitive instruction such as a setting change of the MMU, an enable/disable of the interrupt, etc.

The virtual machine 130 may run an operating system such as the guest operating system 131, and execute the application 132, which may operate as a separate platform.

The guest operating system 131 may run on the virtual machine 130, execute the application 132, and access the hardware 110 to perform a variety of controls.

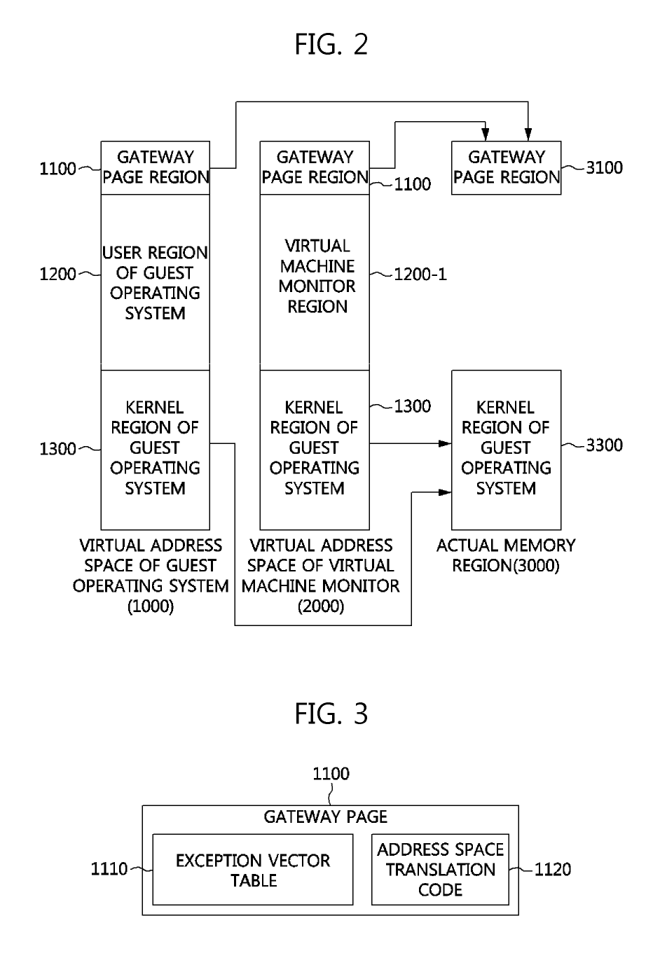

FIG. 2 is a concept view illustrating arrangement of the virtual address space of the guest operating system and the virtual machine monitor according to an embodiment of the present invention.

Referring to FIG. 2, the virtual machine 130 is an environment running the guest operating system 131 and may include a guest operating system user processor and a guest operating system kernel. A virtual address space 1000 of the guest operating system is a virtual address space of the virtual machine 130 running the guest operating system 131 and may include a gateway page region 1100, a user region 1200 of the guest operating system, and a kernel region 1300 of the guest operating system.

The gateway page region 1100 may be mapped to a gateway page region of an actual memory region 3000.

The guest operating system kernel region 1300 is a core region for controlling and scheduling the guest operating system, which may be a region storing kernel code and data of the guest operating system.

The virtual machine monitor 120 may be arranged in a virtual address space separate from the virtual address space 1000 of the guest operating system which is the virtual address space of the virtual machine 130 running the guest operating system 131.

The virtual address space 2000 of the virtual machine monitor 120 may include a gateway page region 1100, a virtual machine monitor region 1200-1, and a guest operating system kernel region 1300.

The gateway page region 1100 of the virtual address space 1000 of the guest operating system and the gateway page region 1100 of the virtual address space 2000 of the virtual machine monitor may share a gateway page stored in a gateway page region which is a predetermined region of an actual memory region 3000.

The guest operating system kernel region 1300 of the virtual address space 1000 of the guest operating system and the guest operating system kernel region 1300 of the virtual address space 2000 of the virtual machine monitor may be mapped to a guest operating system kernel region 3300 which is a predetermined region of the actual memory region.

FIG. 3 is a block diagram illustrating a schematic configuration of the gateway page according to an embodiment of the present invention.

Referring to FIG. 3, the gateway page 1100 is a shared memory page for translation between the virtual address space 1000 of the guest operating system and the virtual address space 2000 of the virtual machine monitor, and is allocated to the gateway page region 3100 of the actual memory region 3000. The gateway page 1100 may be used for translation between the virtual address space 1000 of the guest operating system and the virtual address space 2000 of the virtual machine monitor.

Furthermore, the gateway page 1100 is a shared memory page which is mapped to all virtual address space regions such as the virtual address space 1000 of the guest operating system, the virtual address space 2000 of the virtual machine monitor, etc. by the virtual machine monitor 120, and may include an exception vector table 1110 and an address space translation code 1120.

The exception vector table 1110 may be a mapping table for replacing an interrupt occurring in the guest operating system, an exception for executing an undefined instruction, an instruction for performing an authority-required function of the operating system, for example, a virtualization-sensitive instruction such as a setting change of the MMU, an enable/disable of the interrupt, etc. among instructions executed by the guest operating system 131, with predetermined instructions corresponding to the virtualization-sensitive instruction.

The address space translation code 1129 may be an information code for performing translation between the virtual address space 1000 of the guest operating system and the virtual address space 2000 of the virtual machine monitor, where the virtual address of the guest operating system and the virtual address of the virtual machine monitor are mapped, or a page translation code which is an information code where the virtual address of the guest operating system and the virtual address of the host operating system are mapped.

For example, a region of all the virtual address spaces where the gateway page is mapped may be a 0 to 4 KB region. The 0 to 4 KB region of the virtual address space 1000 of the guest operating system may be set to necessarily map the gateway page 1100 to a region which is not mapped with the actual memory region 3000 for null pointer exception processing.

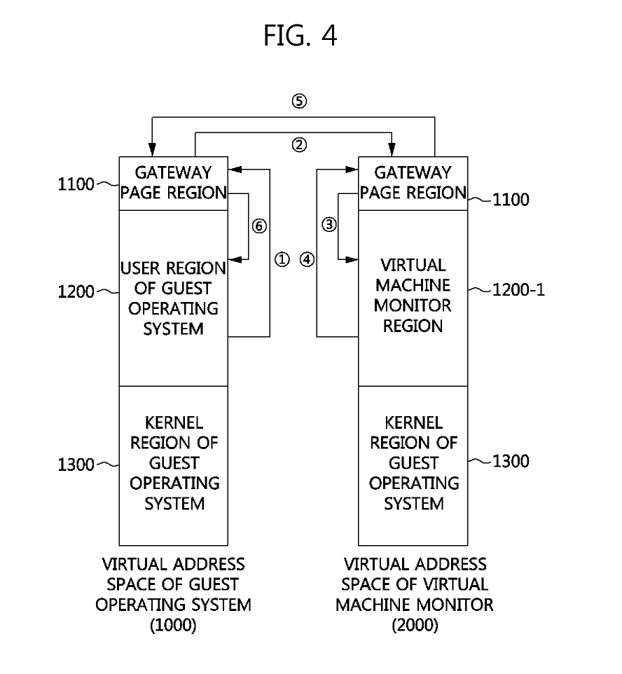

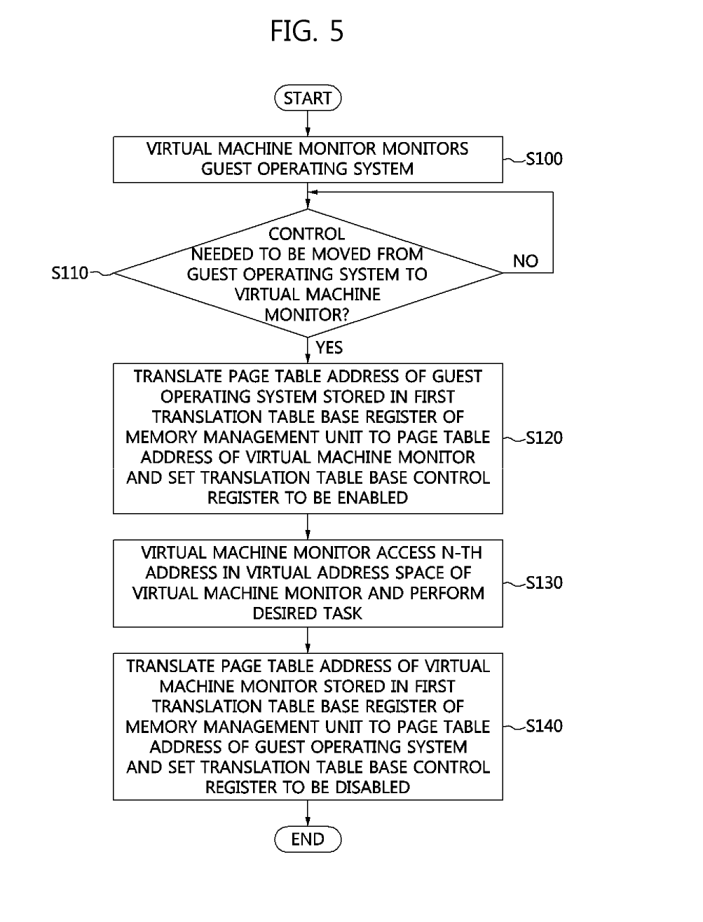

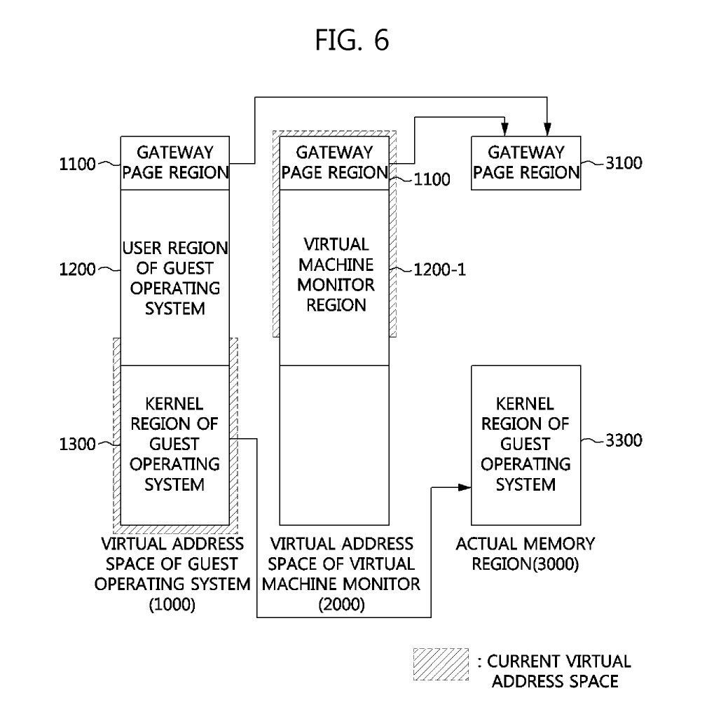

FIG. 4 is a concept view illustrating a control flow when the virtual address space is translated through the gateway page between the guest operating system and the virtual machine monitor according to an embodiment of the present invention. FIG. 5 is a flowchart illustrating a process of translating the virtual address space between the guest operating system and the virtual machine monitor according to an embodiment of the present invention. FIG. 6 is a concept view illustrating arrangement of the virtual address space translated when the virtual machine monitor is executed according to an embodiment of the present invention.

Referring to FIGS. 4 to 6, the virtual machine monitor monitors the guest operating system (S100), and when translation of the virtual address spaces between the guest operating system and the virtual machine monitor is needed as a result of monitoring a virtualization-sensitive instruction, an interrupt, an exception, etc., accesses the gateway page and executes the address space translation code 1120 stored in the gateway page 1100 to execute the translation of the virtual address space (S110).

For example, when the virtualization-sensitive instruction, the interrupt, the exception, etc. are detected during execution of the guest operating system, control is moved from the guest operating system 131 to the gateway page 1100 (\textcircled{1}, \textcircled{2}).

A first translation table base register TTBR0 and a second translation table base register TTBR1 of the memory management unit MMU, which stores an address of the page table for connecting the virtual address space and the actual memory region, store a page table address of the currently running guest operating system, and a translation table base control register TTBCR of the memory management unit is disabled.

Translation of the virtual address space may be performed by translating the page table address of the guest operating system stored in the first translation table base register TTBR0 to the page table address of the virtual machine monitor, and enabling the translation table base control register TTBCR (S120).

When the first translation table base register TTBR0 is translated to the page table address of the virtual machine monitor and the translation table base control register TTBCR is enabled, the virtual address space of the virtual machine monitor may be generated as shown with a dotted line of FIG. 6 (\textcircled{3}).

Specifically, the virtual machine monitor region 1200-1 of the virtual address space, for example, a 0 to 2 GB region, may be a region for execution code and data of the virtual machine monitor. The kernel region of the guest operating system, for example, a 2 to 4 GB region, may be a region for access to the virtual address space of the guest operating system.

That is, the kernel region 1300 of the guest operating system, for example, the 2 to 4 GB region, may be generated the same as the guest operating system by using the untranslated page table address of the guest operating system stored in the first translation table base register TTBR0 and the page table address stored in the second translation table base register TTBR1.

Accordingly, after the virtual address space is translated to the virtual address space of the virtual machine monitor, the virtual machine monitor may access an address N of the virtual address space 2000 of the virtual machine monitor to perform a desired task, instead of accessing an address N of the virtual address space 2000 of the virtual machine monitor, and then instantly apply the results of the performed task to the guest operating system as if the task were performed on the virtual address space 1000 of the guest operating system.

When the virtual address space is translated to the virtual address space 2000 of the virtual machine monitor and then the virtual monitor is executed, the virtual monitor cannot access the user region in the virtual address space 1000 of the guest operating system, for example, the 0 to 2 GB region.

However, the user region of the guest operating system does not have instructions and data to be executed by the virtual machine monitor, and thus the virtual machine monitor does not need to access the region and may access the kernel region 1300 of the guest operating system to control the instructions.

When the execution of the virtual machine monitor is completed, control is moved from the virtual machine monitor to the gateway page (\textcircled{4}, \textcircled{5}). In order to perform translation from the virtual address space 2000 of the virtual machine monitor to the virtual address space 1000 of the gate operating system, the page table address of the virtual machine monitor stored in the first translation table base register TTBR0 of the memory management unit is returned to the page table address of the guest operating system, and the translation table base control register TTBCR of the memory management unit is disabled. Thus, translation(\textcircled{6}) to the virtual address space 1000 of the guest operating system may be performed (S140).

In this case, all the virtual address spaces 1100, 1200, and 1300 of the guest operating system are presented, and the guest operating system may execute an instruction again in the virtual address space selected by the virtual machine monitor.

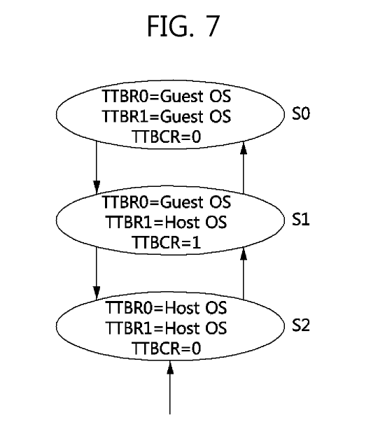

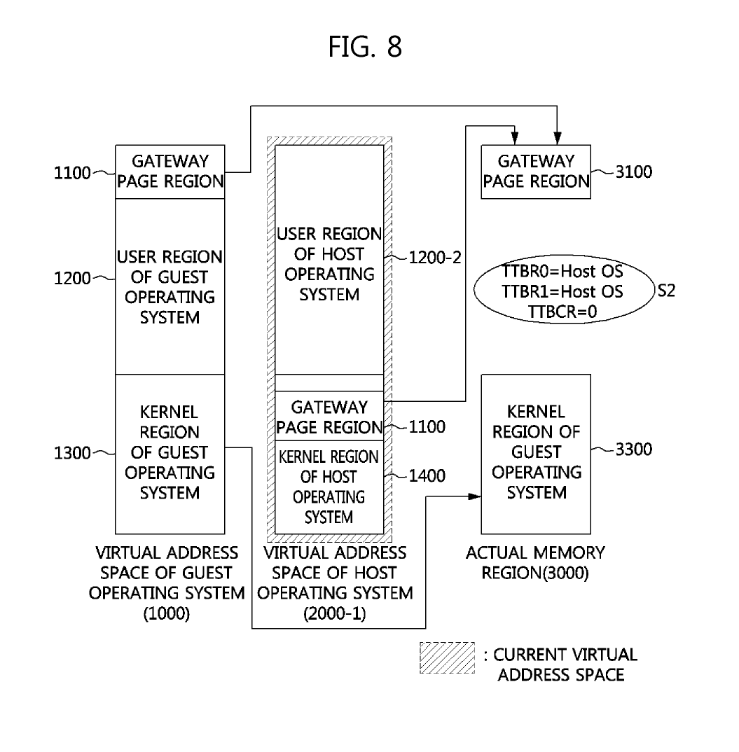

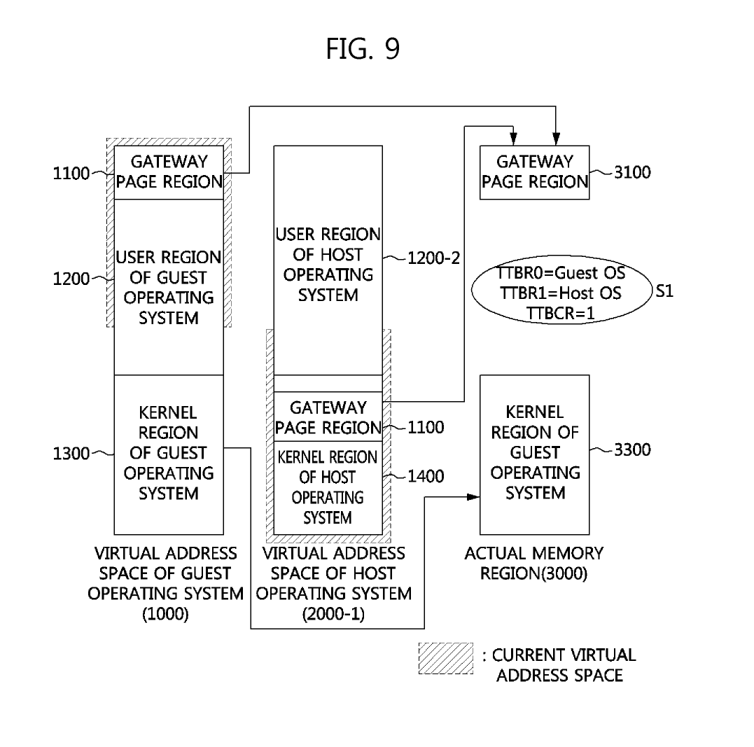

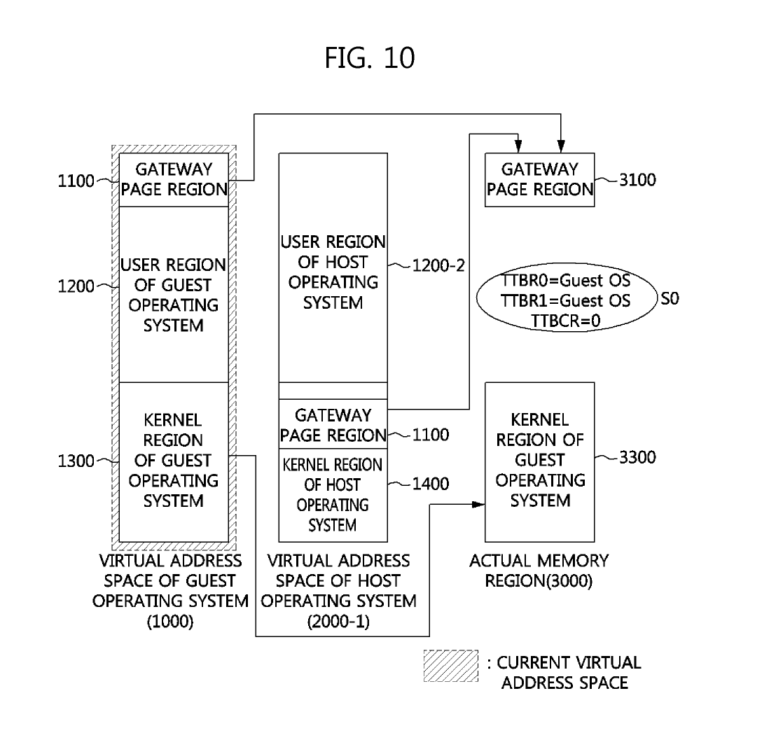

FIG. 7 is a concept view illustrating a process of translating the virtual address space between the guest operating system of the type-2 virtual machine monitor and the virtual machine monitor according to an embodiment of the present invention. FIG. 8 is a concept view illustrating arrangement of the virtual address space in the process S2 of translating the virtual address space in the type-2 virtual machine monitor according to an embodiment of the present invention. FIG. 9 is a concept view illustrating arrangement of the virtual address space in the process S1 of translating the virtual address space in the type-2 virtual machine monitor according to an embodiment of the present invention. FIG. 10 is a concept view illustrating arrangement of the virtual address space in the process S0 of translating the virtual address space in the type-2 virtual machine monitor.

Referring to FIGS. 7 to 10, the type-2 virtual machine monitor may be applied to translate the virtual address space between the host operating system and the guest operating system.

First, the virtual machine monitor may fall into two types according to criteria such as execution layer, execution order, etc. of the virtual machine monitor.

As the guest operating system controls an application, so the type-1 virtual machine monitor, which is referred to as a native VMM, may directly access the hardware. The guest operating system may be a virtual machine monitor executed on the hardware in the second level. The type-1 virtual machine monitor may be, for example, CP/CMS developed at IBM, z/VM, Xen, etc.

The type-2 virtual machine monitor, which is referred to as a host VMM, may be executed on the guest operating system like an application. The guest operating system may be a virtual machine monitor executed on the hardware in the third level. The type-2 virtual machine monitor may be, for example, VMware Sever, VMware Workstation, virtual PC developed at MS.

In order for the type-2 virtual machine monitor to be applied to translate the virtual address space between the host operating system and the guest operating system, as shown in FIG. 7, the virtual address space 2000-1 of the host operating system may include a host operating system user region 1200-2, a host operating system kernel region 1400, and a gateway page region 1100. The virtual address space 2000 of the virtual machine monitor −2 may include a gateway page region 1100, a virtual machine monitor region 1200-1, and a guest operating system kernel region 1200-2.

The virtual address space 1000 of the guest operating system may include the gateway page region 1100, a guest operating system user region 1200, and a guest operating system kernel region 1300.

Also, the gateway page region 1100 of the host operating system and the gateway page region 1100 of the guest operating system may be mapped to the gateway page region 3100 of the actual memory region. The gate operating system kernel region 1300 of the guest operating system may be mapped to the kernel region 3300 of the guest operating system of the actual memory region.

A gateway page is mapped to the gateway page region 1100 allocated to the host operating system kernel region 1300 of the virtual address space 2000-1 of the host operating system. The gateway page may include a page translation code for page translation between the virtual address space 2000-1 of the host operating system and the virtual address space 1000 of the guest operating system.

Also, the gateway page may be mapped to the gateway page region 1100 of the guest operating system, for example, a 0 to 4 KB region of the virtual address space 1000 of the guest operating system. The 0 to 4 KB region is a virtual address space which is not used by most of the guest operating systems, and the guest operating system cannot access the gateway page region 1100.

In order to translate the virtual address space between the virtual address space 2000-1 of the host operating system and the virtual address space 1000 of the guest operating system when the virtual address of the gateway page region 1100 allocated to the virtual address space 2000-1 of the host operating system is different from the virtual address of the gateway page region 1100 allocated to the virtual address space 1000 of the guest operating system, the host operating system may have control when a virtual address space currently used by the host operating system is the virtual address space of the host operating system, the first translation table base register TTBR0 and the second translation table base register TTBR1 of the memory management unit may store a page table address of the host operating system, and the translation table base control register TTBCR may be set to be disabled (S2).

In order to translate the virtual address space 1000 of the guest operating system, by changing a page table address of the host operating system stored in the first translation table base register TTBR0 of the memory management unit to the page table address of the guest operating system, keeping the page table address of the host operating system stored in the second translation table base register TTBR1 of the memory management unit, enabling the translation table base register TTBCR of the memory management unit, and moving control from the host operating system to the gateway page, as shown in FIG. 9, the currently used virtual address space may be set as the guest operating system user region 1200, for example, the 0 to 2 GB region of the guest operating system virtual address space 1000 and the host operating system kernel region 1400, for example, the 2 to 4 GB region of the host operating system virtual address space 2000-1 (S1).

As shown in FIG. 10, the currently used virtual address space may be completely translated to the virtual address space of the guest operating system, by keeping the page table address of the guest operating system stored in the first translation table base register TTBR0 of the memory management unit, changing the page table address of the host operating system stored in the second translation table base register TTBR1 of the memory management unit to the page table address of the guest operating system, and moving control from the current gateway page to the guest operating system.

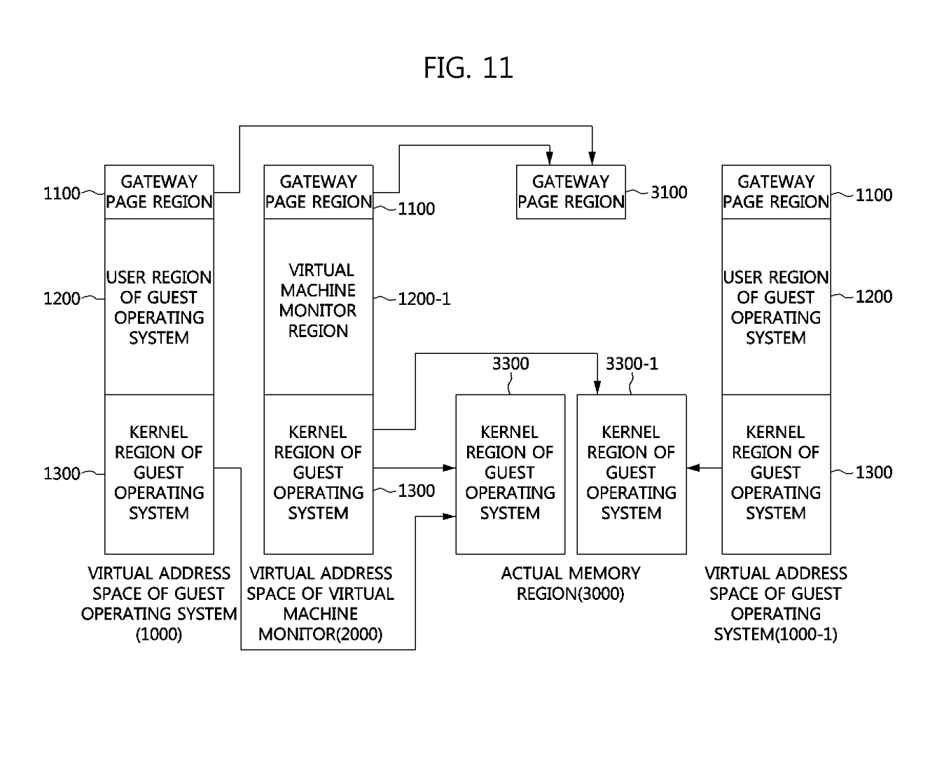

FIG. 11 is a concept view illustrating a relationship of virtual address spaces between a plurality of guest operating systems in a type-2 virtual machine monitor and the virtual machine monitor.

Referring to FIG. 11, when the virtual machine monitor monitors a plurality of guest operating systems, page table information should be kept for translation between the address space of the guest operating system kernel region 1300 of the virtual address space (1000, 1000-1) of each guest operating system and the address space of the guest operating system kernel region (3000, 3000-1) of the actual memory region 3000.

In this case, since the virtual machine monitor region 1200-1 of the virtual address space 2000 of the virtual machine monitor, which stores code and data of the virtual machine monitor, is fixed, but the virtual address space of the guest operating system may be arbitrarily changed, the virtual machine monitor may apply to the page table the virtual address space of each guest operating system obtained by tracking the virtual address space of the guest operating system which is a monitoring target depicted as a dotted line.

Accordingly, when the apparatus for translating virtual address according to an embodiment of the present invention is used as described above, the virtual machine monitor can improve performance of the virtual machine monitor using the page table of the guest operating system again without keeping information of a separate page table for translation between the virtual address space of the virtual machine monitor and the virtual address space of the guest operating system.

The apparatus for translating the virtual address space according to the present invention can map a gateway page allocated to an actual memory area to the virtual address space of the guest operating system and the virtual address space of the virtual machine monitor, and map a kernel area of the guest operating system to the virtual address space of the virtual machine monitor. Thus, the apparatus does not need to map the virtual address space of the guest operating system to the page table of the virtual machine monitor, thereby enhancing performance of the virtual machine and reducing the amount of used memory.

Furthermore, the apparatus can translate the virtual address space using the gateway page and the memory management unit and thus translate the virtual address space with short code, thereby shortening development time of the virtual machine monitor, enhancing stability of the virtual machine monitor, and reducing time consumed for translation of the virtual address space.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for translating a virtual address space comprising:
a virtual address space generation unit generating a virtual address space of a guest operating system, the guest operating system being executed in the virtual address space, and a virtual address space of a virtual machine monitor, the virtual machine monitor being executed in the virtual address space;
a gateway page generation unit generating a gateway page allocated to a predetermined region of an actual memory region and mapped to the virtual address space of the guest operating system and the virtual address space of the virtual machine monitor; and
a memory management unit executing the gateway page to map a kernel region of the guest operating system to the predetermined region of the virtual address space of the virtual machine monitor to perform translation between the virtual address space of the guest operating system and the virtual address space of the virtual machine monitor.

2. The apparatus according to claim 1, wherein the virtual address space of the guest operating system and the virtual address space of the virtual machine monitor are allocated separately.

3. The apparatus according to claim 1, wherein the gateway page is mapped to the same virtual address space in the virtual address space of the guest operating system and the virtual address space of the virtual machine monitor.

4. The apparatus according to claim 3, wherein the gateway page is mapped to a 0 to 4 KB region in the virtual address space of the guest operating system and the virtual address space of the virtual machine monitor.

5. The apparatus according to claim 1, wherein the gateway page comprises:
an exception vector table including mapping table information for replacing a virtualization-sensitive instruction with a predetermined instruction; and
an address space translation code being an information code where the virtual address space of the guest operating system and the virtual address space of the virtual machine monitor are mapped.

6. The apparatus according to claim 1, wherein the memory management unit comprises:
first and second translation table base registers each storing an address of a page table indicating a currently executed virtual address space; and
a translation table base control register controlling operations of the first and second translation table base registers.

7. The apparatus according to claim 6, wherein the memory management unit translates an address of a page table of the guest operating system stored in the first translation table base register to an address of a page table of the virtual machine monitor when the currently executed virtual address space is the virtual address space of the guest operating system, and translation from the virtual address space of the guest operating system to the virtual address space of the virtual machine monitor is required, and
keeps the address of the page table of the guest operating system stored in the second translation table base register, and enables the translation table base control register to map the kernel region of the guest operating system to the predetermined region of the virtual address space of the virtual machine monitor.

8. The apparatus according to claim 7, wherein the memory management unit translates an address of a page table of the virtual machine monitor stored in the first translation table base register to an address of a page table of the guest operating system when the currently executed virtual address space is the virtual address space of the virtual machine monitor, and translation from the virtual address space of the virtual machine monitor to the virtual address space of the guest operating system is required, and
keeps the address of the page table of the guest operating system stored in the second translation table base register, and disables the translation table base control register to translate the virtual address space of the virtual machine monitor to the virtual address space of the guest operating system.

9. An apparatus for translating a virtual address space comprising:
a virtual address space generation unit generating a virtual address space of a guest operating system, the guest operating system being executed by the virtual address space, and a virtual address space of a host operating system executed, the host operating system being executed by the virtual address space;
a gateway page generation unit generating a gateway page allocated to a predetermined region of an actual memory region and mapped to the virtual address space of the guest operating system and the virtual address space of the host operating system; and
a memory management unit executing the gateway page to map a guest operating system user region of the guest operating system to the predetermined region of the virtual address space of the host operating system to perform translation between the virtual address space of the guest operating system and the virtual address space of the host operating system.

10. The apparatus according to claim 9, wherein the gateway page is mapped to a different virtual address space in the virtual address space of the guest operating system and the virtual address space of the host operating system.

11. The apparatus according to claim 10, wherein the gateway page is mapped to a 0 to 4 KB region of the virtual address space of the guest operating system and a host operating system kernel region of the virtual address space of the host operating system.

12. The apparatus according to claim 9, wherein the gateway page comprises:
an exception vector table including mapping table information for replacing a virtualization-sensitive instruction with a predetermined instruction; and
an address space translation code being an information code where the virtual address space of the guest operating system and the virtual address space of the host operating system are mapped.

13. The apparatus according to claim 9, wherein the memory management unit comprises:
first and second translation table base registers each storing an address of a page table indicating a currently executed virtual address space; and
a translation table base control register controlling operations of the first and second translation table base registers.

14. The apparatus according to claim 13, wherein the memory management unit translates an address of a page table of the host operating system stored in the first translation table base register to an address of a page table of the guest operating system when the currently executed virtual address space is the virtual address space of the host operating system, and translation from the virtual address space of the host operating system to the virtual address space of the guest operating system is required, and
keeps the address of the page table of the host operating system stored in the second translation table base register, and enables the translation table base control register to map the guest operating system user region of the guest operating system to the predetermined region of the virtual address space of the host operating system.

15. The apparatus according to claim 14, wherein the memory management unit keeps an address of a page table of the guest operating system stored in the first translation table base register when the currently executed virtual address space is the virtual address space of the guest operating system, and translation from the virtual address space of the guest operating system to the virtual address space of the host operating system is required, and
translates an address of a page table of the host operating system stored in the second translation table base register to the address of the page table of the guest operating system, and disables the translation table base control register to translate the virtual address space of the host operating system to the virtual address space of the guest operating system.
